(19) United States
(12) Patent Application Publication
(10) Pub. No.: US 2014/0124614 A1
(43) Pub. Date: May 8, 2014

(54) RADIO-CONTROLLED HELICOPTER

(71) Applicants: Enrico Maria Bernabei, Rimini (IT); Stefano Baiardi, Savignano Sul Rubicone (Forli e Cesena) (IT)

(72) Inventors: Enrico Maria Bernabei, Rimini (IT); Stefano Baiardi, Savignano Sul Rubicone (Forli e Cesena) (IT)

(73) Assignee: SAB HELI DIVISION S.R.L., San Mauro Pascoli (Forli e Cesena) (IT)

(21) Appl. No.: 14/124,021

(22) PCT Filed: Jun. 6, 2012
(86) PCT No.: PCT/IB2012/052856

§ 371 Date: Dec. 5, 2013

(30) Foreign Application Priority Data
Jun. 7, 2011 (IT) RN2011A000042
Jun. 7, 2011 (IT) RN2011A000043

(51) Int. Cl. B64C 27/04

(52) U.S. Cl. CPC B64C 27/04
USPC 244/17.11

(57) ABSTRACT

Described is a radio-controlled helicopter comprising a main body, a tail beam, connecting means operating between the main body and the tail beam for connecting the tail beam to the main body; the tail beam has a first end close to the main body and a second end away from the main body and it is defined by a tapered tubular member with a cross-section at the first end greater than the cross-section at the second end; the connecting means comprise an engagement member integral with the tail beam in the first end and a seat for the engagement member made in the main body, and fixing means operating between the engagement member and the main body at the seat.

### TECHNICAL FIELD

This invention relates to a radio-controlled helicopter and in particular to a radio-controlled helicopter comprising a main or central body and a tail beam connected to the main body and supporting a group of rear blades.

### BACKGROUND ART

The prior art radio-controlled helicopters comprise a load-bearing structure defined by a main body to which a tail beam is connected.

At present, a prior art tail beam for radio-controlled helicopters is made from a tubular member, with a constant cross-section, generally circular in shape, normally extruded from material such as aluminium. The tubular member is then connected to the main body of the helicopter by a pair of transversal members which interface with the tubular member, forming a fitting between between tubular member and main body.

The above-mentioned structure is relatively not very rigid, especially at the coupling of the tail beam to the main body.

To overcome this lack of rigidity of prior art systems supplementary stiffening members are often used such as, for example, tie rods and the like which, however, at the same time can weigh down and complicate the structure of the helicopter in its entirety and the functionality of the tail beam in particular.

Moreover, the interlocking connection system described above does not help to reduce the damage to the main body of the helicopter since in the event of crashing the connection point is stressed enormously due to the high forces in play caused by the impact, thereby irreparably damaging the main body.

Relative to the main body, at present, in the field of radio-controlled helicopters, the central or main body defines the frame which is able to support all the apparatuses and components which realise all the most important functions of the helicopter.

The central body supports, amongst other things, the motor, the power transmission, the bearings for the main rotor axis and the actuators which control the geometry of the rotor head. The tail beam is also connected to the central body.

Currently, the main body of radio-controlled helicopters comprises two suitably shaped thin plates, normally made of aluminium or composite material, located alongside each other and joined together by various transversal members locked with threaded couplings on the plates.

The set of transversal members and the two plates fulfil the above-mentioned support needs.

The system described is however complex. The time for assembly of the transversal members is lengthy since the majority of the above-mentioned apparatuses and components are attached to the main body by threaded couplings. Even the maintenance is consequently complex. For example, it is easy to damage one of the two plates following a crash of the model, with the consequent need to dismantle the majority of the helicopter to replace the damaged part.

### DISCLOSURE OF THE INVENTION

In this context, the main technical purpose of this invention is to provide a radio-controlled helicopter which overcomes the above-mentioned disadvantages.

One aim of this invention is to provide a radio-controlled helicopter the tail beam of which fulfils the necessary mechanical rigidity requirement.

Another aim is to provide a radio-controlled helicopter the tail beam of which allows a better distribution of the weights compared with the prior art solutions thereby reducing as much as possible the cantilever masses.

A further aim is to define a connecting system between bean and main body designed to minimise the damage resulting from the crash.

Yet another aim is to provide a radio-controlled helicopter the assembly and maintenance of which is simpler compared with prior art solutions.

The technical purpose indicated and the aims specified are substantially achieved by a radio-controlled helicopter according to claim 1 and one or more of the following claims.

More specifically, the tail beam is made from printed composite material tubular in shape with a variable cross-section. The tail beam is then connected to the main body by a system normally known as “V” joint which with the use of correctly designed connecting devices determines a system for joining the tail beam to the main body of a collapsible type so as to achieve the aim of reducing damage in the case of a heavy crash.

The main body is formed by a compact unit made entirely of light alloy material which is able to independently support all the apparatuses and components which cause the above-mentioned functions. By optimising the layout of the various components following this solution a very compact central body can be made which satisfies all the structural needs of the radio-controlled helicopter.

### BRIEF DESCRIPTION OF THE DRAWINGS

Further features and advantages of the invention are more apparent in the detailed description below, with reference to a preferred, non-limiting, embodiment of a radio-controlled helicopter as illustrated in the accompanying drawings, in which:

FIG. 1 is a schematic perspective rear view of a radio-controlled helicopter according to this invention;

FIG. 2 is a partly exploded schematic perspective rear view of the radio-controlled helicopter of FIG. 1;

FIG. 3 is a partly exploded schematic perspective view of a scaled-up detail of the radio-controlled helicopter of the previous figures;

FIG. 4 is a schematic cross-section through line IV-IV of FIG. 1;

FIG. 5 is a schematic perspective front view of the helicopter of the previous figures;

FIG. 6 is a partly exploded schematic perspective front view 2 of the helicopter of the previous figures;

FIG. 7 is a second schematic perspective view of a scaled-up detail with some parts cut away for better clarity of the radio-controlled helicopter of the previous figures;

FIG. 8 is a schematic cross-section through line VIII-VIII of FIG. 7 with some parts cut away for better clarity.

### DESCRIPTION OF THE PREFERRED EMBODIMENTS OF THE INVENTION

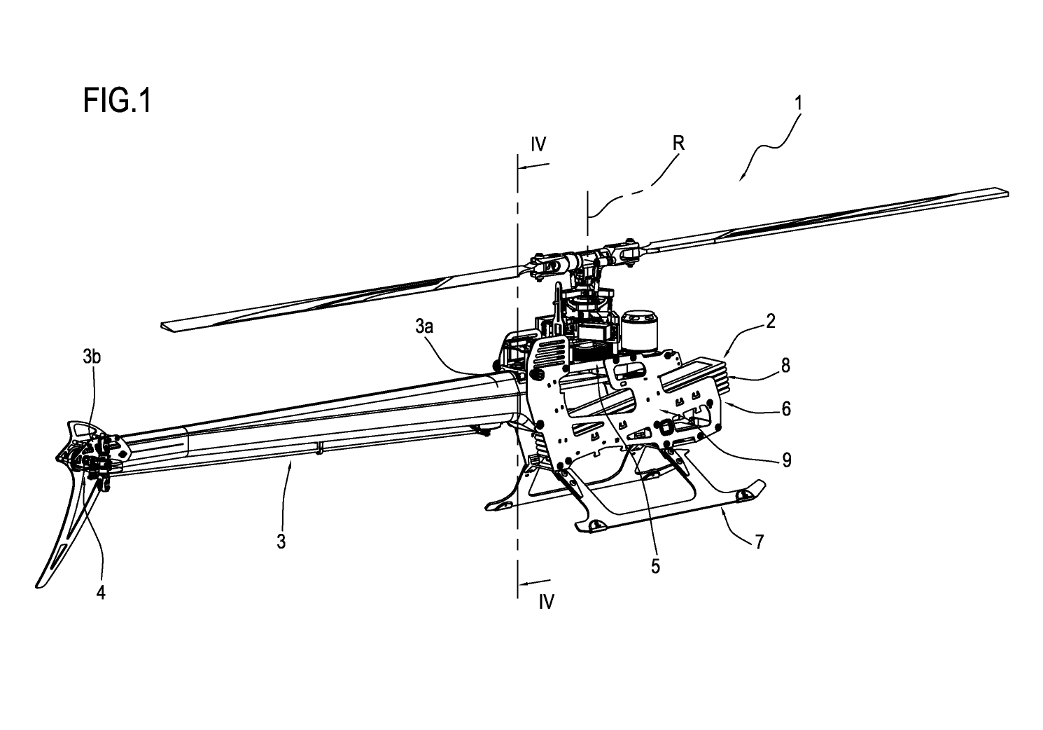

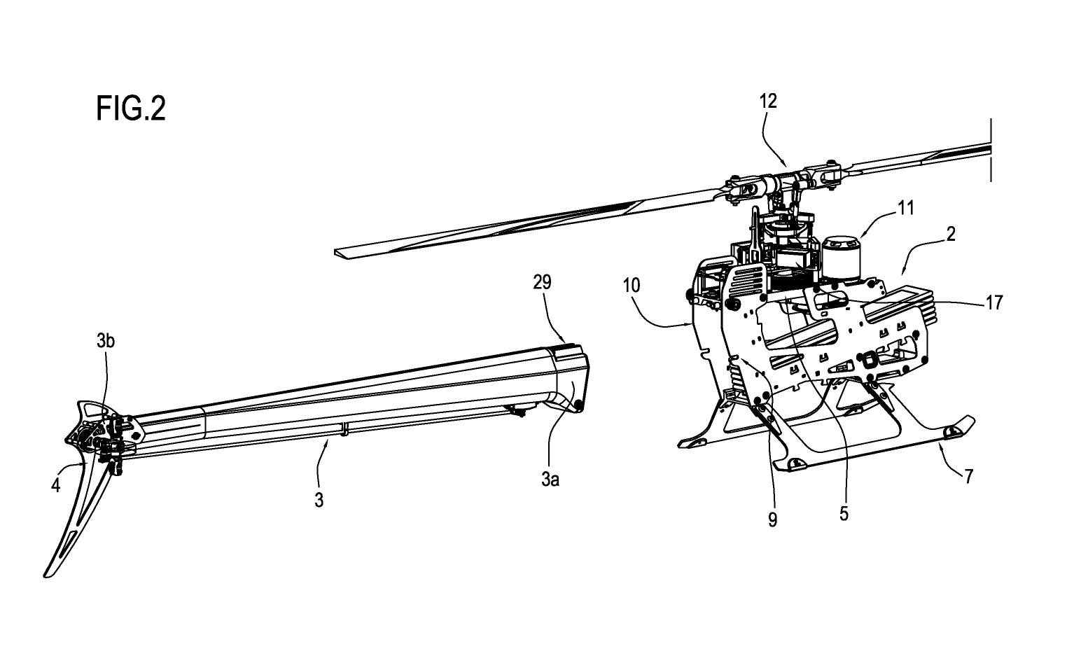

With reference to the accompanying drawings, with particular reference to the FIGS. 1 to 5, the numeral 1 denotes a radio-controlled helicopter according to this invention.

The helicopter 1 is described below solely for he parts necessary or the understanding of this invention.

The helicopter 1 comprises a main body 2 and a tail beam 3 connected to and supported by the main body 2.

The beam 3 can be removed from the main body 2, as described in more detail below.

More specifically, the beam 3 has a first end 3a connected, so close, to the main body 2 and a second end 3b, away from the main body 2.

The tail beam 3 is made from composite materials of a substantially know type and, advantageously, has a tapered tubular profile with the cross-section at the first end 3a greater than the cross-section at the second end 3b.

The tail beam 3 is, in other words, defined by a tapered tubular member with the cross-section at the first end 3a greater than the cross-section at the second end 3b.

As illustrated, the variation of the cross-section occurs as a reduction in the direction from the main body 2 towards the end 3b of the tail beam 3.

The beam 3 is therefore made from a member with a tubular cross-section, the cross-section of which is variable along the longitudinal extension of the beam 3.

The helicopter 1 comprises a tail unit 4, comprising the tail blades not illustrated, connected to the beam 3 at the end 3b of the beam, that is, the tail beam 3 performs a structural function of supporting the tail beam 4.

In practice, the tail beam 3 for radio-controlled helicopters supporting the tail unit 4 according to this invention can have various forms, is made using composite materials, is made with a tubular shape with a variable cross-section having the larger cross-section closer to the main body 2 of the helicopter and the smaller cross-section at the point furthest from the body 2 with the aim of optimising the rigidity of the body for best supporting the tail unit 4.

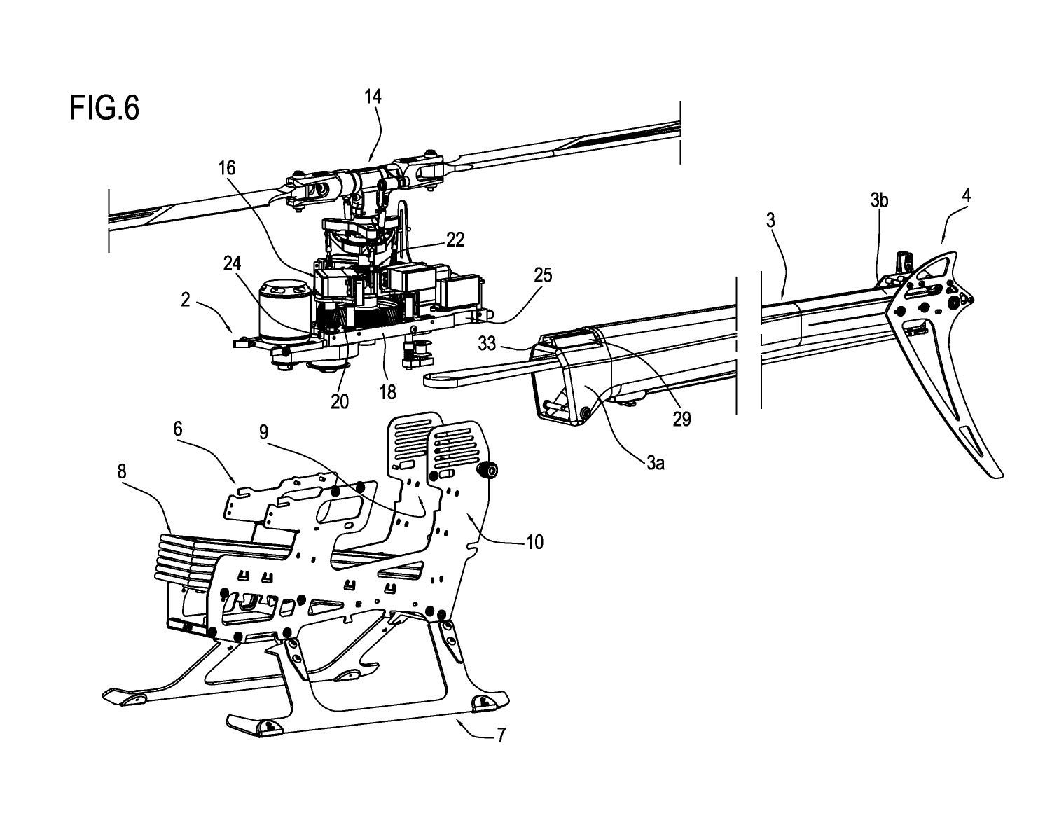

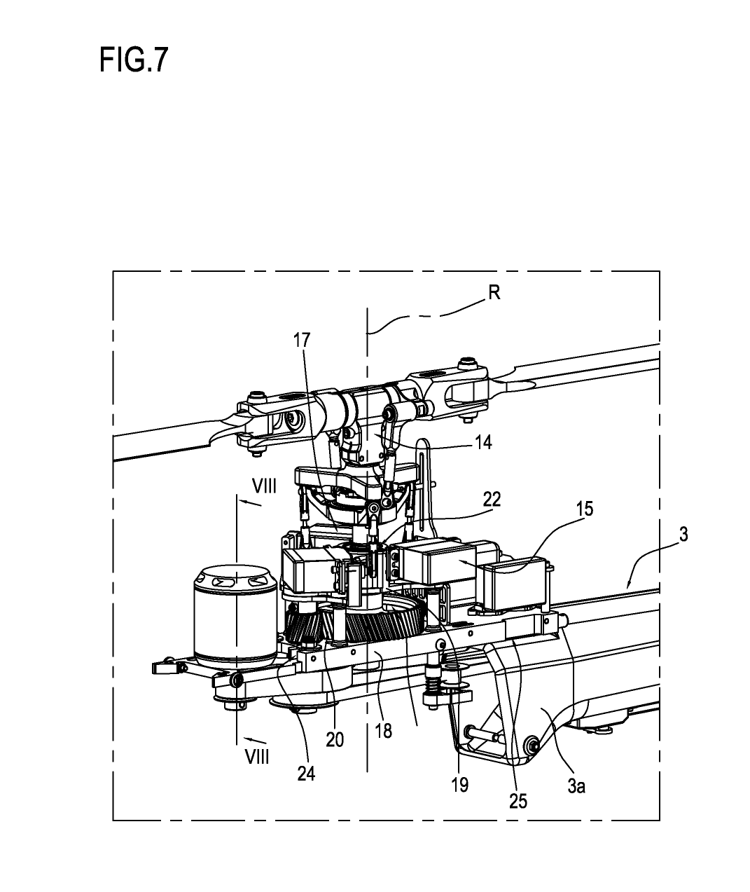

Looking in more detail at the main body 2, with reference in particular to FIGS. 6 and 7, it should be noted that the main body 2 comprises a central support 5.

The helicopter 1 comprises a battery unit 6 connected to the central support 5.

More precisely, the so-called battery unit 6 comprises a carriage 7 for resting the helicopter 1 and the power supply battery 8 on the ground.

The unit 6 is equipped with a first and a second side 9, 10 associated with each other and between which the battery 8 is inserted.

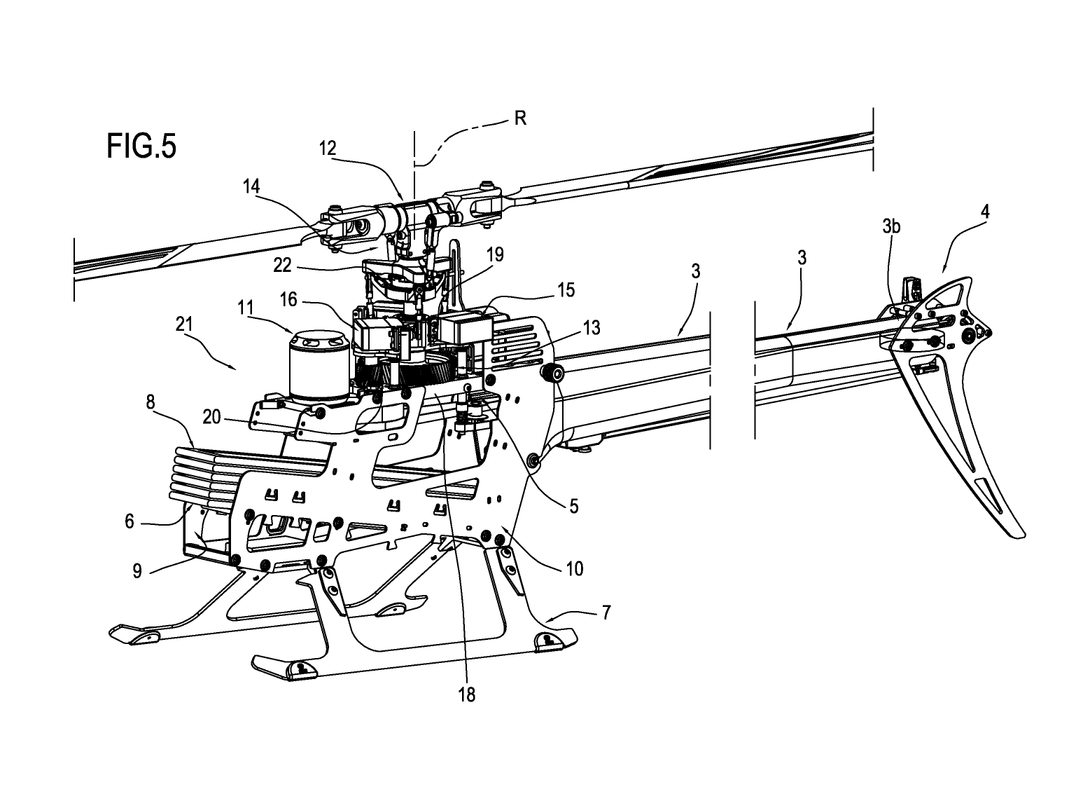

The central support 5 is fastened, that is connected, to the unit 6 at the top observing in particular FIGS. 5 and 6 whilst the carriage 7 is positioned on the opposite side of the central support 5 relative to the sides 9 and 10.

As illustrated, the sides 9 and 10 are suitably shaped, at the top, for the coupling with central support 5 and at the bottom for the coupling with the carriage 7.

In the example illustrated, the helicopter 1 comprises a motor unit 11, a rotor unit 12 and a drive unit 13 operating between the motor unit 11 and the rotor unit 12.

The rotor unit 12 comprises a rotor 14 and a corresponding rotor shaft 14a, having an axis R of rotation, and a plurality of actuators 15, 16, 17 for controlling the rotor 14.

Advantageously, the actuators 15, 16 and 17 are located about the axis R of rotation; each actuator is spaced from the adjacent actuator by 120 sexagesimal degrees.

The actuators 15, 16 and 17 are also directed in such a way that they occupy as little space as possible in the direction of the axis R of rotation.

The central support 5 of the main body 2 for the radio-controlled helicopter 1 supports the actuators 15, 16, 17 and/or the drive unit 13 and/or other functions of the helicopter 1; the central support 5 defines a positioning of the actuators 15, 16 and 17 positioning them about the rotor shaft 14a directing them so as to minimise the space they occupy as a function of their shape in the direction of the rotor shaft 14a.

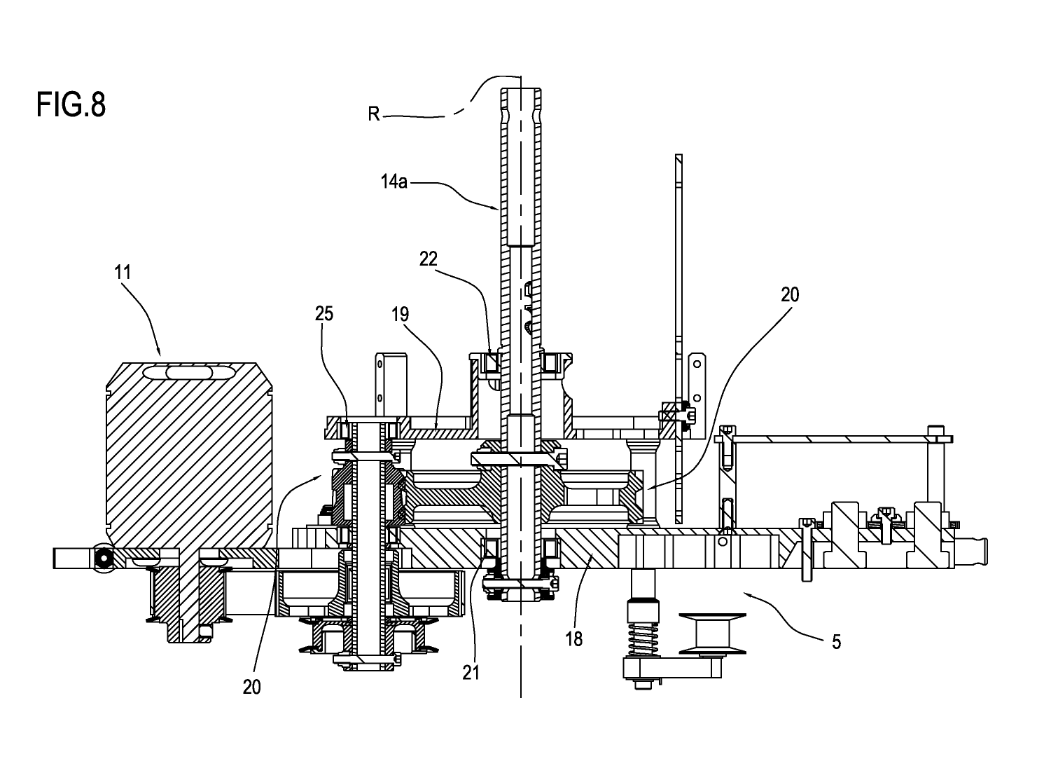

With reference in particular to FIG. 8, it should be noted that the central support 5 comprises a first supporting member 18 or main member combined with a second supporting member 19 or secondary member.

In practice, the first supporting member 18 is coupled with the second supporting member 19 to form the central support 5 of the helicopter 1.

In other words, the central support 5 is made from the first supporting member 18, or main member, joined to the second supporting member 19, or secondary member.

In an alternative embodiment not illustrated, he main member 18 integrates the secondary member 19.

The central support 5 is made from the main member 18 joined to the secondary member 19 or integrating the secondary member 19.

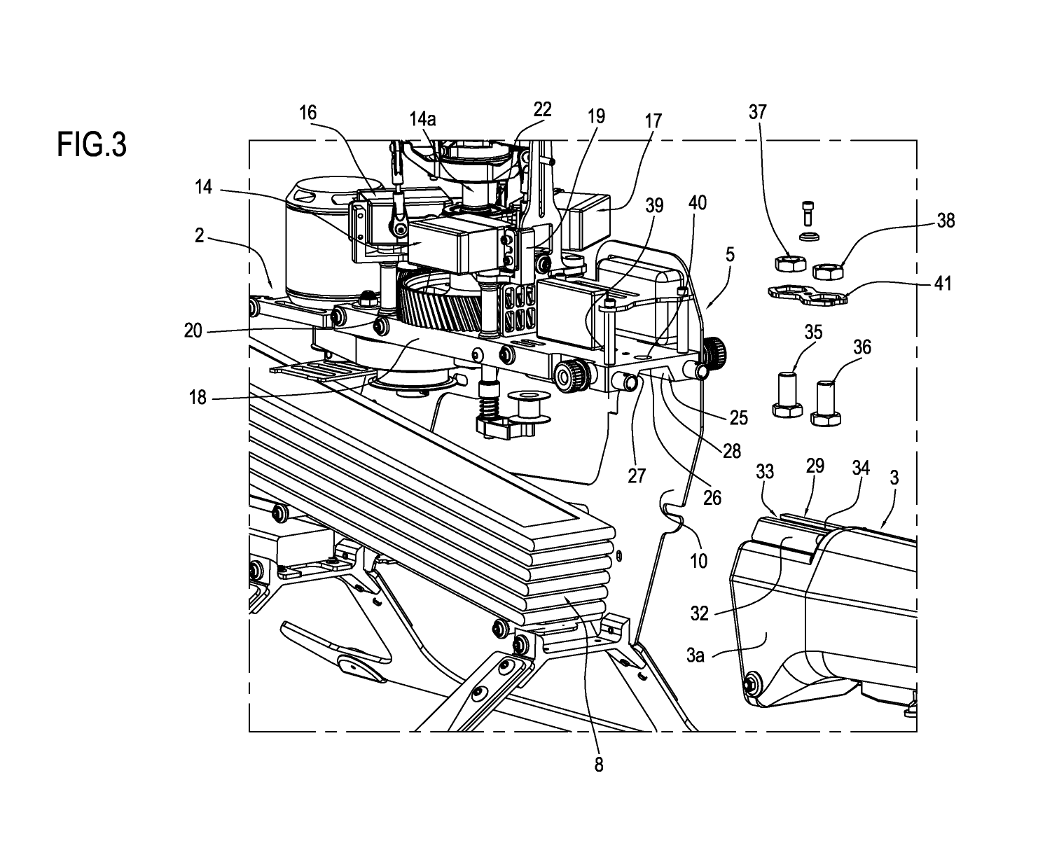

With reference in particular to FIGS. 3, 5, 7 and 8, looking in more detail at the above-mentioned drive unit 13, it should be noted that the drive unit comprises the means for transmitting motion from the motor unit 11 to the rotor shaft 14a and a plurality of bearings 21, 22, 23 supporting the transmission means 20.

The helicopter 1 comprises the transmission means 20 positioned between the first supporting member 18 and the second supporting member 19.

The helicopter 1 comprises the bearings 21, 22 and 23 positioned outside the first supporting member 18 and the second supporting member 19 relative to the transmission means 20.

In practice, the transmission means 20 are wrapped between the supporting members 18 and 19 and the bearings 21, 22, 23 on the outside in such a way that the rigidity of the drive unit 13 is maximised.

In other words, the transmission means 20 carrying the motion to the rotor shaft 14a about the axis R are positioned between the members 18 and 19. The transmission means 20 are wrapped by the two members 18 and 19 in such a way that the bearings 21, 22, 23 can be placed outside the means 20 thus maximising the rigidity of the drive.

With reference in particular to FIG. 7, it should be noted that the central support 5, in particular the first supporting member 18, comprises a seat 24 for coupling the motor unit 11 to the support 5.

The central support 5 comprises a zone allowing the fixing of the motor unit 11 defined by the seat 24.

The central support 5, in particular the first supporting member 18, also comprises a second seat 25 for coupling the tail beam 3 to the main body 2.

More generally, the main body 2 has the seat 25 for coupling the body 2 to the tail beam 3.

The central support 5 comprises a zone allowing the joining of the tail unit 4 defined by the seat 25.

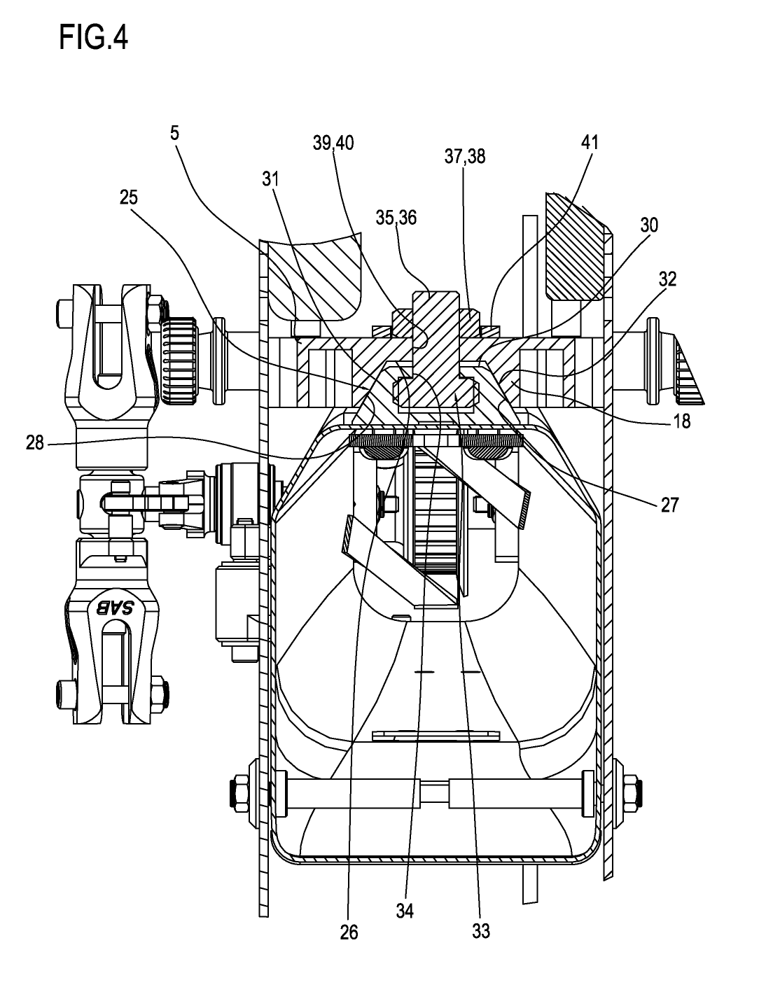

The seat 25 has an upturned V-shaped transversal cross-section considering the helicopter 1 resting on the ground using the carriage 7 as clearly shown in FIG. 4.

The seat 25 has a base wall 26 and a first and a second side wall 27, 28 which define the sides of the V-shaped cross-section.

The tail beam 3 comprises an engagement member 29 designed to engage in the seat 25.

In other words, the tail beam 3 has at its end 3b the member 29 integral with it designed to interface with an opposite zone belonging to the main body 2.

The engagement member 29 has a substantially upturned V-shaped external profile considering the helicopter 1 resting on the ground using the carriage 7 as clearly shown in FIG. 4.

The external profile of the engagement member 29 has a base wall 30 and a first and a second side well 31, 32 which define the sides of the V-shaped cross-section of the external profile.

When the tail beam 3 is coupled to the main body 2 the sides 31 and 32 of the engagement member 29 are respectively abutted against the sides 28 and 27 of the seat 25.

The engagement member 29 and the zone of the seat 25 interface with each other through contact with surfaces with properties defined by the V-shaped transversal cross-section.

Preferably, the engagement member 29 is made from light alloy and is integrated in the tail beam 3 which, as mentioned above, is preferably made from composite material.

As illustrated, the member 29 has a recess 33 open at the top as illustrated in FIG. 4 which extends according to the main direction of extension of the tail beam 3.

The recess 33 has an upturned T-shaped transversal cross-section; the transversal cross-section of the recess 33 is defined by a leg of the “T” which extends parallel to the axis R of rotation and a head of the “T” which extends transversally, more precisely perpendicularly, to the above-mentioned leg.

As illustrated, the leg of the “T” faces upwards; in other words, the base wall 30 of the engagement member 29 has a groove 34, defining the leg of the “T”.

The radio-controlled helicopter 1 comprises means for securing the tail beam 3 to the main body 2 using the engagement member 29 and the seat 25.

The securing means comprise, as illustrated in the accompanying drawings, a pair of bolts 35, 36 combined with the respective nuts 37, 38.

Advantageously, the bolts 35, 36 are of a collapsible type, that is, designed to break or fracture in the case of impact so as to prevent damage as much as possible both to the main body 2 and the tail beam 3 of the helicopter 1.

In practice, the bolts 35, 36 have a predetermined failure load less than, in particular, at least that of the main body 2 and of the tail beam 3.

In the preferred embodiment illustrated, the bolts 35 and 36 are made of nylon® suitably sized.

As illustrated, the bolts 35, 36 are inserted with their head in the recess 33 in such a way that the threaded portion protrudes from the groove 34.

The main body 2, in particular the central support 5, has a pair of through holes 39, 40 in which the bolts 35, 36 are respectively inserted.

The nuts 37 and 38 keep the tail beam 3 coupled with the main body 2 applying a pulling action using the bolts 35, 36.

The helicopter 1 comprises a safety element 41, for example in the form of a plate, shaped for coupling with the nuts 37 and 38 and preventing accidental unscrewing.

In practice, the tail beam 3 is joined to the main body 2 using the member 29 with V-shaped transversal cross-section generally made from light alloy integrated with the tail beam 3 which in turn forms a very practical and effective joint with the main body 2, the latter equipped with the seat 25 also with a V-shaped transversal cross-section which is able to accommodate the engagement member 29.

Looking more closely at the constructional details, FIG. 4 illustrates the tail beam 3 joined to the main body 2. The member 29 is joined securely to the beam 3; Using the connecting means 35, 36, 37 and 38 the engagement member 29 interfaces with and joins the seat 25 of the main body 2.

The bolts 35, 36 use the T-shaped recess 33 for putting into contact the surfaces of the member 29 and the seat 25.

The engagement member 29 is locally removed so as to allow the entry of the joining elements embodied by way of an example by the bolts 35 and 36.

To prevent unscrewing of the nuts 37, 38 from the respective bolts 35, 36 the safety element 41 is used. The latter is a plate with at least one hexagonal seat designed to lock the respective nut 37, 38 in the clamping position reached.

in short, the invention described above provides a system which is able to reach the maximum rigidity of the tail beam together with improved distribution of the weights giving the possibility of tapering the cross-section provided by the method of making the beam. The connecting system based on the coupling of V-shaped profiles, joined by correctly sized connecting means, such as the bolts 35 and 36, forms a collapsible joint which is able to reduce the damage assuming crashing of the model.

In practice, in case of crashing, the bolts 35 and 36 break and the V-shaped profiles of the engagement member 29 and of the seat 25 allow disengagement of the tail beam 2 from the main body 3.

The coupling system of the tail beam 3 as described allows a disengagement of the beam 3 from the main body 2 in case of impact with the ground with a significant reduction of the damage to the helicopter 1.

The invention has important advantages, the helicopter 1 is robust, with facilitated maintenance and adjustment due to the presence of the central support.

The helicopter 1 is also less disposed to damage in case of crashing due to the tail beam solution which is disengageable or collapsible.

The invention described above makes it possible to obtain a main body which is extremely compact and solid. All the major components are joined to the central support and the maximum rigidity of the assembly is therefore guaranteed. If the model crashes the body described is, in short, indestructible.

1. A radio-controlled helicopter comprising a main body, a tail beam, connecting means operating between the main body and the tail beam for connecting the tail beam to the main body, the tail beam having a first end close to the main body and a second end away from the main body and being defined by a tapered tubular member with the cross-section at the first end greater than the cross-section at the second end, the radio-controlled helicopter wherein the connecting means comprise an engagement member integral with the tail beam in the first end and a seat for the engagement member made in the main body, the connecting means also comprising fixing means operating between the engagement member and the main body at the seat.

2. The radio-controlled helicopter according to claim 1, wherein the seat has a V-shaped transversal cross-section delimited by a base wall and a first and a second side wall defining the sides of the V-shaped cross-section, the engagement member having a substantially V-shaped external profile delimited by a respective base wall and a first and a second side wall forming the sides of the V-shaped cross-section of the external profile of the engagement member, the sides of the engagement member being respectively abutted against the sides of the seat when the tail beam is coupled to the main body.

3. The radio-controlled helicopter according to claim 1, wherein it comprises a rotor having an axis of rotation and also being characterised in that engagement member has a recess open at the top extending according to the main direction of extension of the tail beam, the recess having a T-shaped transversal cross-section and defined by a leg of the “T” extending parallel to the axis of rotation and a head of the “T” extending perpendicularly to the leg, a base wall of the engagement member having a groove defining the leg, the fixing means comprising a pair of bolts combined with respective nuts, the bolts being inserted with a head in the recess in such a way that a respective threaded portion protrudes from the groove, the main body having a pair of through holes in which the bolts are respectively inserted, the nuts keeping the tail beam coupled with the main body applying a pulling action using the bolts.

4. The radio-controlled helicopter according to claim 3, wherein the bolts are breakable in a predetermined manner.

5. The radio-controlled helicopter according to claim 3, wherein it comprises a safety element shaped for coupling with the nuts for preventing unscrewing.

6. The radio-controlled helicopter according claim 1, wherein the main body comprises a central support comprising a first supporting member and a second supporting member joined together for forming the central support, the helicopter comprising a drive unit comprising means for transmitting motion and a plurality of bearings supporting the transmission means, the transmission means being positioned between the first supporting member and the second supporting member, the bearings being positioned outside the first supporting member and the second supporting member relative to the transmission means, the transmission means being wrapped between the first and second supporting members and the bearings being outside the first and second supporting member.

7. A radio-controlled helicopter comprising a main body, a tail beam, connecting means operating between the main body and the tail beam for connecting the tail beam to the main body, wherein the main body comprises a central support comprising a first supporting member and a second supporting member joined together for forming the central support, the helicopter comprising a drive unit comprising means for transmitting motion and a plurality of bearings supporting the transmission means, the transmission means being positioned between the first supporting member and the second supporting member, the bearings being positioned outside the first supporting member and the second supporting member relative to the transmission means, the transmission means being wrapped between the first and second supporting members and the bearings being outside the first and second supporting member.
